(19) United States
(12) Patent Application Publication
(10) Pub. No.: US 2008/0162530 A1
(43) Pub. Date: Jul. 3, 2008

(54) Method and Apparatus for Utilizing an Extensible Markup Language Data Structure For Defining a Data-Analysis Parts Container For Use in a Word Processor Application

(75) Inventors: Paul van Eikeren, Bend, OR (US); Joshua S. van Eikeren, Bend, OR (US)

Correspondence Address: PAUL VAN EIKEREN;BLUE REFERENCE, INC., 2554 NW 1ST ST., BEND, OR, 97701, US

(73) Assignee: Blue Reference, Inc., Bend, OR (US)

(21) Appl. No.: 11/619,316

(22) Filed: Jan. 3, 2007

(51) Int. Cl. G06F 17/27

(52) U.S. Cl. 707/102; 707/104.1; 707/E17.055

(57) ABSTRACT

A computer-readable extensible markup language data structure comprising structural elements for defining a data-analysis parts container in a data-analysis template comprising a word processor document is disclosed. The computer-readable data structure is comprised of at least one properties element for receiving properties associated with the data-analysis parts container and at least one data-analysis parts element for receiving data-analysis parts, wherein the properties and data-analysis parts elements define the data-analysis container. The computer-readable extensible markup language data structure allows the user/programmer to perform data analysis within the familiar environment of a word processor application using data-analysis templates. The extensible markup language data structure also allows the user/programmer to generate a programmable object model for accessing XLM-defined resources of the data-analysis parts container.

### CROSS-REFERENCE TO RELATED APPLICATIONS

U.S. patent application Attorney Docket No. BLUEREF-002, filed on Jan. 3, 2007 and entitled “Method and Apparatus for Managing Data-Analysis Parts in a Word Processor Application,” U.S. patent application Attorney Docket No. BLUEREF-003, filed on Jan. 3, 2007 and entitled “Object-Oriented Framework for Data-Analysis Having Pluggable Platform Runtimes and Export Services,” and U.S. patent application Attorney Docket No. BLUEREF-004, filed on Jan. 3, 2007 and entitled “Method and Apparatus for Data Analysis in a Word Processor Application,” which are assigned to the same assignee as the present invention, are hereby incorporated, in their entirety, by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademarks Office patent or records, but otherwise reserves all copyright rights whatsoever.

### BACKGROUND

Data analysis is a process involving the organization, examination, display, and analysis of collected data using narratives, figures, structures, charts, graphs and tables. Data analyses are aided by data-analysis processors, which are computational engines, either in hardware or software, which can execute the data analysis process. High-end data-analysis processor typically have a language component like the R, S, SAS, Mathlab®, Python, and Perl families of languages. The availability of a language component facilitates data analysis in numerous ways including the following: application of arbitrary data transformations; applying one analysis result to results form another; abstraction of repeated complex analysis steps; and development of new methodology.

A principal challenge of using data-analysis processors is communicating the results of data analysis to data owners. Generation of reports as part of a data analysis project typically employs two separate steps. First, the data are analyzed using a data-analysis application based on a data analysis processor. And two, data analysis results (tables, graphs, figures) are used as the basis for a report document using a word processor application. Although, many data analysis applications try to support this process by generating pre-formatted tables, graphs and figures that can be easily integrated into a report document using copy-and-paste from the data analysis application to the word processor application, the basic paradigm is to construct the report document around the results obtained from data analysis.

Another approach for integration of data analysis and report document generation is to embed the data analysis itself into the report document. The concept of “literate programming systems”, “literate statistical practice” and “literate data analysis” are big efforts in this area. Proponents of this approach advocate software systems for authoring and distributing these dynamic data-analysis documents that contain text, code, data, and any auxiliary content needed to recreate the computations. The documents are dynamic in that the contents, including figures, tables, etc., can be recalculated each time a view of the document is generated. The advantage of this integration is that it allows readers to both verify and adapt the data analysis process outlined in the document. A user can readily reproduce the data analysis at any time in the future and a user can present the data analysis results in a different medium.

Whatever the precise merits and features of the prior art in this field, the earlier art does not achieve or fulfill the purposes of the present invention. The prior art does not provide for the following:
the capability to perform word processing and data analysis within a single integrated environment;
the capability of providing an integrated container for holding a plurality of data-analysis parts and data-analysis part types in an electronic document for maintaining all data-analysis parts in one place;
the capability of providing a programmable object model for allowing a user/programmer to access the integrated container for holding a plurality of data-analysis parts and data-analysis part types; and
the capability of providing a data-analysis template for generating standardized formats for data-analysis results documents in a word processor application;

Accordingly, a need exists for computer-implemented applications, methods and systems that enable users to integrate data analysis and data-analysis results generation using familiar software applications like a word processor application.

### SUMMARY

In accordance with the present invention, the above and other problems are solved by providing a computer-readable extensible markup language data structure, and a method for utilizing the computer-readable data structure, the data structure comprising structural elements for defining a data-analysis parts container in a data-analysis template comprising a word processor document. The extensible markup language data structure is comprised of at least one properties element for receiving properties associated with the data-analysis container and at least one data-analysis parts element for receiving data-analysis parts, wherein the at least one properties element and the at least one data-analysis parts element define the data-analysis parts container in the data-analysis template comprising a word processor document.

The extensible markup language schema may entail a properties element comprising an attribute identifying a data-analysis processor. In one embodiment, the computer-readable extensible markup language data structure may entail a data analysis parts element comprising an element comprising at least one attribute for defining a data-analysis part, wherein the part is selected from a group of data-analysis part types comprising: a data set; an object; an expression; a chemical structure; a chemical reaction structure; a reaction table; a process pathway; a spectrum; and a chromatogram. In another embodiment, the extensible markup language data structure may entail a data-analysis parts element comprising at least one element selected from a plurality of elements, the plurality of elements comprising: an element for defining the data-analysis part associated with a data set; an element for defining the data-analysis part associated with an object; an element for defining the data-analysis part associated with a code block; an element for defining the data-analysis part associated with an expression; an element for defining the data-analysis part associated with a chemical structure; an element for defining the data-analysis part associated with a chemical reaction structure; an element for defining the data-analysis part associated with a reaction table; an element for defining the data-analysis part associated with a formulations table; an element for defining the data-analysis part associated with a process pathway; an element for defining the data-analysis part associated with a spectrum; and an element for defining the data-analysis part associated with a chromatogram. The extensible markup language data structure is operative with a method of use and operative on a computer-readable medium.

Also in accordance with the present invention, the aforementioned computer-readable extensible markup language data structure for defining a data-analysis parts container is operative on a computer-readable medium comprising a data-analysis template for use in data analysis in a word processor application, the data-analysis template comprising: a serialized word processor document, wherein presentation content and data content may be separated; a serialized data-analysis parts container; and program modules for communicating a data-analysis part between the word processor document and the data-analysis parts container.

In one embodiment, the computer-readable medium may entail a word processor document generated using Word developed by Microsoft Corporation. In another embodiment, the computer-readable medium may entail a serialized data-analysis parts container selected from a group of file types comprising: an extensible markup language file; a binary file; and a text file. In other embodiments, the computer-readable medium may entail a serialized data-analysis parts container which is embedded in: the data content of the word processor document; a bookmark in the word processor document; and in a field in the word processor document. In further embodiments, the computer-readable medium may entail program modules generated using smart document technology and smart document technology implemented using Visual Studio Tools for Office developed by Microsoft Corporation.

Embodiments of the present invention also provide a programmable object model for accessing the resources of a data-analysis parts container comprising an extensible markup language data structure, the model comprising: an application programming interface for allowing a user to programmatically access resources defined in the computer-readable extensible markup language data structure defining a data-analysis parts container; said application programming interface comprising a message call for requesting association of one or more XML-defined resources to a data-analysis parts container object; and said application programming interface operative to receive a return value from the data-analysis parts container object responsive to association of the one or more XML-defined resources to the data-analysis parts container object. Further embodiments of the present invention additionally provide a computer-readable medium comprising a data-analysis template for use in data analysis in a word processor application, the data-analysis template comprising: a serialized word processor document, wherein presentation content and data content may be separated; a serialized data-analysis parts container; and program modules for communicating a data-analysis part between the word processor document and the data-analysis parts container.

### BRIEF DESCRIPTION OF THE DRAWINGS

FIG. 1 is a block diagram of a computing apparatus that may operate in one exemplary embodiment of the present invention.

FIG. 2 is a block diagram illustrating interaction between entities outlined in the claims of the present invention and a word processor application, which may operate in one exemplary embodiment of the present invention.

FIG. 3 illustrates the relations of elements in a first exemplary computer-readable XML data structure in accordance with the present invention.

FIG. 4 illustrates the relationship of elements in a second exemplary computer-readable XML data structure in accordance with the present invention.

FIG. 5 is a block diagram illustrating the relationship of XML elements in one embodiment of a data-analysis parts container in accordance with the claims of the invention.

FIG. 6 illustrates the relationships of FIG. 5 as an exemplary XML schema in accordance with the claims of the invention.

FIG. 7 is a block diagram illustrating the relationship of XML elements in another embodiment of a data-analysis container in accordance with the claims of the invention.

FIG. 8 illustrates the relationships of FIG. 7 as an exemplary XML schema in accordance with the claims of the invention.

FIG. 9 is a logical flow diagram of an exemplary process for generating a computer-readable XML data structure for defining a data-analysis parts container in accordance with the claims of the invention.

FIG. 10 shows an exemplary XML data structure for a data-analysis parts container comprising a data set in accordance with the claims of the invention.

FIG. 11 shows an exemplary XML data structure for a data-analysis parts container comprising a code block in accordance with the claims of the invention.

FIG. 12 is a simplified block diagram illustrating interaction between software objects according to an object oriented programming model.

FIG. 13 illustrates the graphical user interface of an exemplary word processor application using a data-analysis template.

FIG. 14 illustrates an exemplary integrated development environment for a data-analysis parts container using an embodiment of the programmable object model in accordance with the claims of the invention.

DEFINITION LIST

| Term | Definition |
|---|---|
| attribute | As used herein, the term “attribute” refers to an additional |
| | property set to a particular value and associated with the |
| | element. Elements may have an arbitrary number of attribute |
| | settings associated with them, including none. Attributes may |
| | be used to associate additional information with an element |
| | that is not a structural element, or may be used be used to |
| | contain text and other content regions. |
| chemical reaction structure | As used herein, the term “chemical reaction structure” refers |
| | to a data-analysis part type for representing a chemical |
| | reaction in terms of the structures and associated metadata |
| | of the reactants and products. |
| chemical structure | As used herein, the term “chemical structure” refers to a |
| | data-analysis part type for representing the structure and |
| | associated metadata of a chemical entity. |
| chromatogram | As used herein the term “chromatogram” refers to a data- |
| | analysis part type for representing the composition and |
| | separation of entities in complex material mixtures. |
| code block | As used herein, the term “code block” refers to a logical |
| | grouping of computer-readable instructions comprising one |
| | or more lines of programming code, which may be contained |
| | in a data-analysis parts container and which may be executed |
| | by a data-analysis processor. |
| data analysis | As used herein, the term “data analysis” refers to the process |
| | of collecting, organizing, examining, displaying and |
| | analyzing collected data using narratives, charts, graphs, |
| | figures and tables. Data analysis may include the following: |
| | processing data in order to draw inferences and conclusions; |
| | systematically applying statistical and logical techniques to |
| | describe, summarize, and compare data; and systematically |
| | studying the data so that its meaning, structure, |
| | relationships, origins and other properties are understood. |
| data set | As used herein, the term “data set” refers to a computer- |
| | readable collection of related data organized and structured |
| | according to one or more defined data structures including, |
| | but not limited to the following: vector, array, matrix, list, |
| | data frame, tuple, table, record, tree and graph. Data sets |
| | may be serialized, for example, to text documents in |
| | conformance to well-defined formats such as StatDataML, an |
| | XML format for statistical data, and to binary formats. |
| data structure | As used herein, the term “data structure” refers to a |
| | computer-readable entity for storing data in a computer so |
| | that it can be used efficiently. Data structures may be |
| | implemented using the data types, references and operations |
| | on them provided by a programming language. |
| data-analysis part | As used herein, the term “data-analysis part” refers to a |
| | computer-readable component entity involved in data |
| | analysis including but not limited to the following: data sets, |
| | formulas, algorithms, models, code blocks, expressions, code |
| | libraries, scripts, instructions, software objects, files, dynamic |
| | and static libraries, packages, statistical components, |
| | simulation components, graphing components, database |
| | components, files, and records. |
| data-analysis part type | As used herein, the term “data-analysis part type” refers to a |
| | named class of data-analysis parts. |
| data-analysis parts container | As used herein, the term “data-analysis part container” refers |
| | to a computer-readable container entity, such as an object |
| | that holds other objects, for holding one or more data- |
| | analysis parts. |
| data-analysis processor | The term “data analysis processor” refers to a computational |
| | engine used in a computer for performing data-analysis on a |
| | data-analysis container for generating a data-analysis results |
| | collection. A data-analysis processor may be implemented |
| | via a data-analysis object-oriented framework comprising a |
| | collection of co-operating components implemented in |
| | hardware or software. A data-analysis processor may include |
| | a dynamic programming language, a library of methods, and |
| | a runtime with an application programming interface. |
| data-analysis template | As used herein, the term “data-analysis template” refers to |
| | computer-readable data structure comprising a word |
| | processor document and a data-analysis parts container, |
| | where the template may serve as a master or pattern for the |
| | generation of a data-analysis results collection and/or a |
| | data-analysis results document. Data-analysis templates |
| | allow the data-analysis results collection and the data- |
| | analysis results document to have content which is structured |
| | and formatted in standardized and recognizable ways. |
| document | As used herein, the term “document” refers to a computer- |
| | readable document object entity, which may be structured as |
| | a document object model. A document is instantiated in a |
| | word processor application and may be serialized, for |
| | example, to a web page for viewing, to a disk for storage as a |
| | file or to a printer for hard copy. |
| element | As used herein, the term “element” refers to the basic unit of |
| | an XML document. An element may be comprised of |
| | attributes, other elements, text and other content regions. |
| formulation table | As used herein, the term “formulation table” refers to a data- |
| | analysis part type for representing the data and metadata |
| | associated with a material formulated from a plurality of |
| | components. |
| markup language | As used herein, the term “markup language” (“ML”) refers to a |
| | language of special codes within a document that specify how |
| | parts of the document are to be interpreted by an application. |
| | In a word processor file, the markup language may specify |
| | how the text is to be formatted or laid out. |
| object | As used herein, the term “object” is a principal building block |
| | in object-oriented design or programming. It refers to a |
| | computer-readable concrete realization, an instance, of a |
| | class that consists of data and the operations associated with |
| | that data. |
| process pathway | As used herein, the term “process pathway” refers to a data- |
| | analysis part type for representing the pathway of material |
| | and energy flows in a process. |
| reaction table | As used herein, the term “reaction table” refers to a data- |
| | analysis part type for representing the data and metadata |
| | associated with a chemical reaction. |
| smart document technology | As used herein, the term “smart document technology” refers |
| | to a collection of Microsoft technologies, which employ XML |
| | and programmatic customization to provide context sensitive |
| | information in Microsoft Office documents within the |
| | standard product interface. |
| spectrum | As used herein the term “spectrum” refers to a data-analysis |
| | part type for representing the interaction of a material with |
| | energy in the electromagnetic spectrum. |
| structural elements | As used herein, the term “structural element” refers to an |
| | element that is comprised of other elements. |
| word processor | As used herein, the term “word processor” refers to a |
| | computer application operative to provide functionality for |
| | creating, displaying, editing, formatting and printing |
| | electronic documents. |

### DETAILED DESCRIPTION

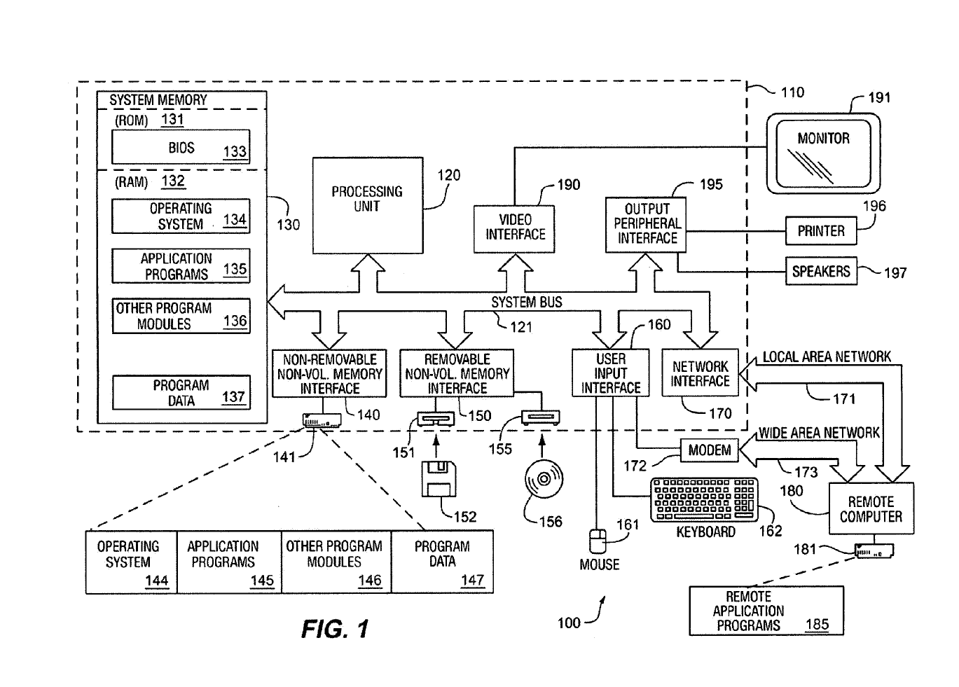

Referring now to the drawings, in which like numerals represent like elements through several figures, aspects of the present invention and the exemplary operating environment will be described. FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, and other computer instructions or components that perform particular tasks or implement particular abstract data types. The methods and apparatus may also be practiced in distributed computing environments where tasks are performed by remote processing devices that are linked through a communications network, such as web services. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates the following: operating system 134, such as the WINDOWS XP operating system from Microsoft Corporation of Redmond, Wash.; application programs 135, such as the word processor Word developed by Microsoft Corporation; other program modules 136, such as data-analysis processors including R from the R-PROJECT, S-Plus from INSIGHTFUL CORPORATION, PYTHON from the PYTHON SOFTWARE FOUNDATION, MATLAB from MATHWORKS CORPORATION, and PERL from the PERL FOUNDATION; and program data 137, such as a data-analysis template comprising a word processor document, for example in the form of a WORD word processor program document and a data-analysis parts container. It should further be appreciated that the various aspects of the present invention are not limited to word processing applications programs but may also utilize other application programs 135 which are capable of processing data-analysis parts, such as spreadsheet (e.g., EXCEL spreadsheet program from MICROSOFT CORPORATION) and presentation (e.g., POWERPOINT presentation program from MICROSOFT CORPORATION) application programs.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

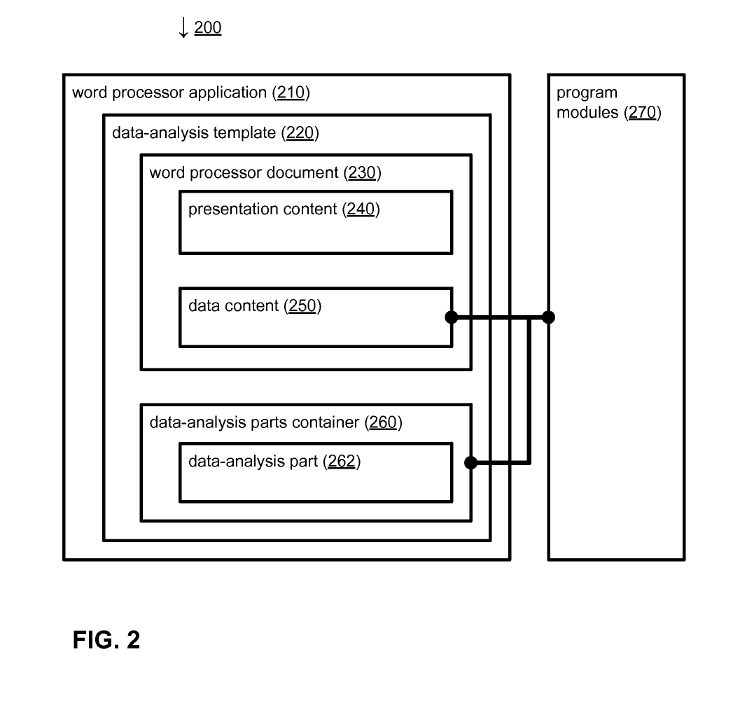

As described below, embodiments of the present invention may be implemented through the interaction of software objects in conjunction with components of the Extensible Markup Language (XML). FIG. 2 is a block diagram illustrating interaction between entities outlined in the claims of the present invention and a word processor application 210 which may operate in one exemplary embodiment of the present invention. As is well known by those skilled in the art, the Extensible Markup Language (XML) provides a method for describing text and data in a document by allowing a user to create element (tag) names that are applied to text and data in a document that in turn define the text and data to which associated tags are applied. For example, referring to FIG. 2, the data-analysis template 220 used by the word processor application 210 is comprised of a word processor document 230 and a data-analysis parts container 260. The word processor document 230 is constructed such that presentation content 240 may be separated from data content 250. The data-analysis parts container 260 is comprised of one or more data-analysis parts 262.

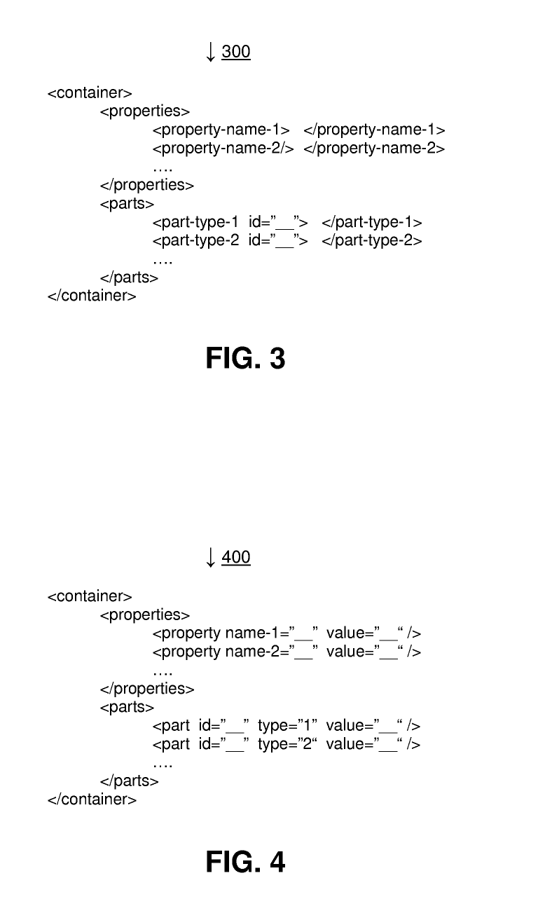

One embodiment of the invention entails a data-analysis parts container for defining data-analysis parts comprising a computer-readable XML data structure. For example referring to FIG. 3, an exemplary data-analysis parts container is identified by <container> and <container/> starting and ending XML nodes. The container is comprised of <properties> and <parts> child nodes, which are optional nodes for separating the properties and part classes. Within the properties node are elements defined by a property-name, which may contain content associated with said property-name. Within the part node are elements defined by a part-type, which may also contain content associated with said part-type, and may also include an identifier (id) when, for example, there is a need to distinguish a plurality of parts of the same part-type. FIG. 4 illustrates another exemplary data-analysis parts container, functionally analogous to the one illustrated in FIG. 3 described by XML nodes, wherein content associated with an element name is maintained in element attributes.

Those skilled in the art of XML will recognize that a user is free to create their own elements by assigning their choice of property-name and part-type to elements, and similarly to attributes. Furthermore, the user is free to add additional child nodes and attributes, thereby having complete control of the definition of the contents of the data-analysis parts container. Then, so long as any downstream consuming application or computing machinery is provided instructions as to the definitions of the named elements and attributes, that application or computing machine may utilize the data in accordance with the semantic meaning of the elements and attributes. For example, if the user assigns “PlatformKey” to property-name-1 with content “BlueRef.R”, an application program can recognize this as a data-analysis parts container that is part of a data-analysis template that is employing the BlueRef.R data-analysis processor.

According to embodiments of the present invention, the computer-readable XML data structure of the data-analysis container 260 may be saved according to a variety of different file formats and according to the native application with which the container is created. For example, a data-analysis template 220 comprising a data-analysis parts container 260 may be saved according to the word processor application 210. According to some embodiments, the data-analysis parts container 250 is embedded in the data content 250 of the word processor document 230 wherein the presentation content and the data content may be separated. For example, the XML data structure corresponding to the data-analysis parts may be maintained as a string within a field, bookmark or node in the word processor document. Alternatively, the XML data structure corresponding to the data-analysis parts container may be saved as an XML file and embedded in a collection of files packaged as a word processor file, such as a ZIP container. For a discussion of an illustrative file format which allows separation of content and data within a document associated with a word processor application see U.S. patent application entitled “Structuring Data for Word Processing Documents,” U.S. Ser. No. 11/398,339, filed Apr. 5, 2006, which is incorporated herein by reference as if fully set out herein. In such cases, the word processor document 230 is saved according to the word processor application 210, including but not limited to text, XML and binary formats. In another embodiment of the invention, the data-analysis parts container 260 comprising an XML data structure may be saved as a file in an XML format. Accordingly, downstream or third party applications capable of understanding data saved as XML may open and consume the contents of the data-analysis parts container or alternatively may be used to generate the XML data structure and the contents of the data-analysis container.

In order to provide a definitional framework for XML elements applied to the data-analysis parts container and data-analysis parts, XML schema files may be created, which contain information necessary for allowing users and consumers of marked up and stored data to understand the XML element (tag) definitions designed by the creator of the data-analysis container. Each schema file, also referred to in the art as a XSD file, preferably includes a listing of all the XML elements (tags) that may be applied to the data-analysis container according to a given schema file and may include rules for the use of the elements.

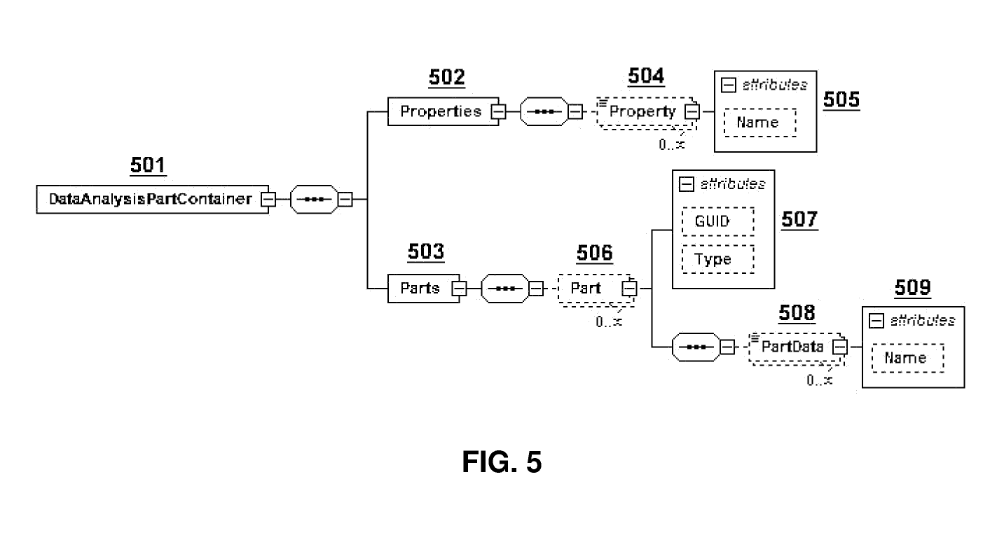

Referring now to FIG. 5, the structure of an illustrative XML schema for defining the properties and content of a data-analysis parts container will be described. The structure of the illustrative schema FIG. 5 includes a DataAnalysisPartContainer element 501 for holding a Properties element 502 and a Parts element 503. The Properties element 502 may contain zero or more occurrences of a Property element 504, which may contain attributes 505 like Name. The Parts element 503 may contain zero or more occurrences of a Part element 506, which may contain attributes 507 like a globally unique ID (GUID) or a type and may contain a Part Data element 508, which further may contain an attribute 509 like Name.

The Properties element 502 is a collection of zero or more Property elements 504 utilized to define properties associated with the DataAnalysisPart Container element 501. The Property element 504 is used to contain one instance of a property and may hold an attribute Name such as the name of the data-analysis processor associated with the DataAnalysisPartContainer or the Name of a reference to libraries or packages useful for performing data analysis. The Parts element 503 is a collection of zero or more Part elements 506 utilized to contain the attributes and content of data-analysis parts. A Part element 506 is used to contain one instance of a part and may have attributes including a globally unique ID (GUID) and may have a part type. The Part Type is utilized to define the data-analysis part and includes but is not limited to the mutually exclusive Part Types DataSet, EmbeddedObject, CodeBlock and Expression. Type elements that are children of Part are mutually exclusive in that only one of them may be defined for a particular Part. A Part element 506 is also used to contain the data associated with one instance of a part as a Part Data 508. A Part Data 508 has an attribute like Name, which can be utilized to contain part data including but not limited to the following: a label naming the part data, a file extension defining the file type containing the part data, an original file name defining the originating file containing the part data, an alias file name defining the file containing the part data, and the file contents comprising a serialized instance of the file contents.

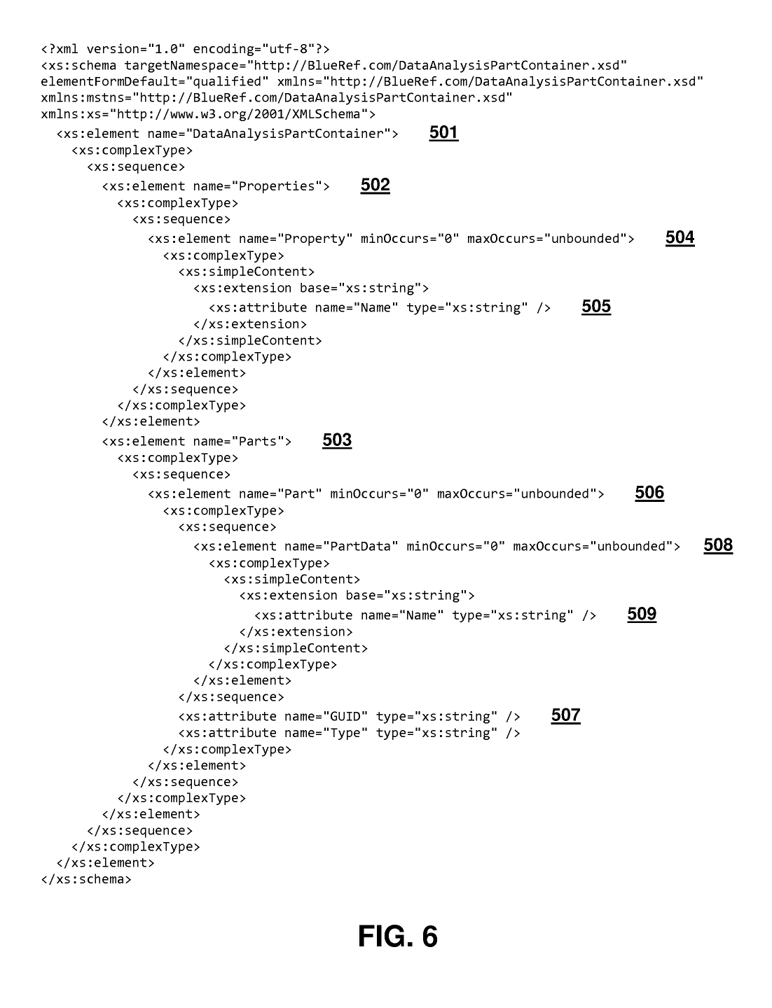

Referring now to FIG. 6, the structure of the schema in FIG. 5 is illustrated using the W3C Schema Definition Language, which is an XML language for describing and constraining the content of XML documents. FIG. 6 illustrates an Extensible Markup Language Schema that includes a parent DataAnalysisPartContainer element 501 with child elements comprising a Properties element 502 and a Parts element 503. The Properties element 502 may contain a child element Property 504, which may have an attribute Name 505. The Parts element 503 may contain a child element Part 506, which may have an attribute GUID and may have an attribute Type Name 507. The Part element 506 may further contain a child element PartsData 508, which may have an attribute Name 509.

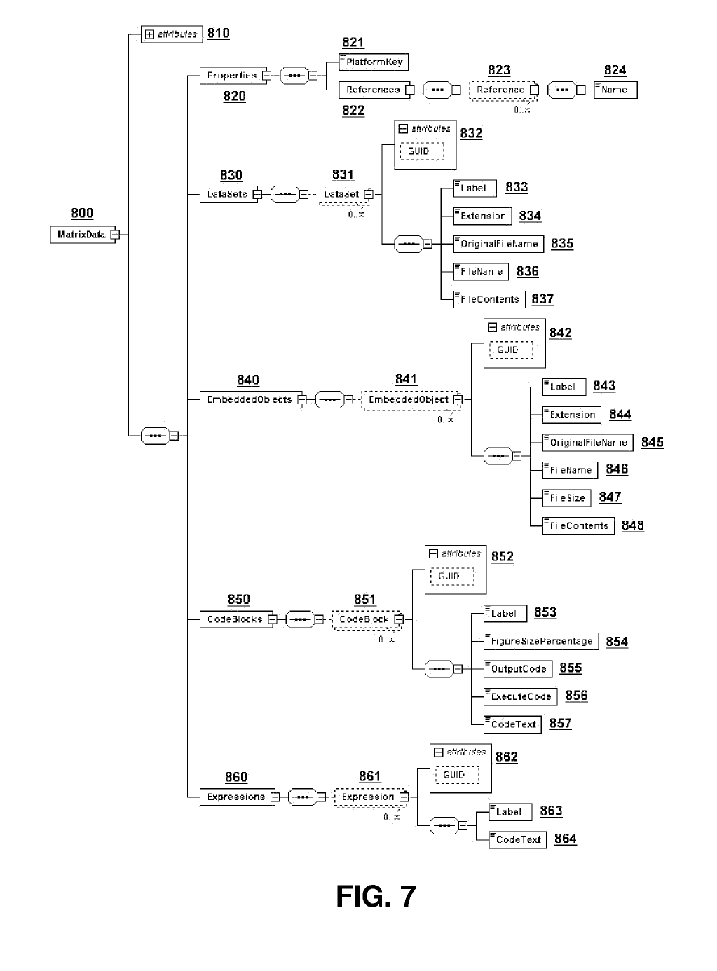

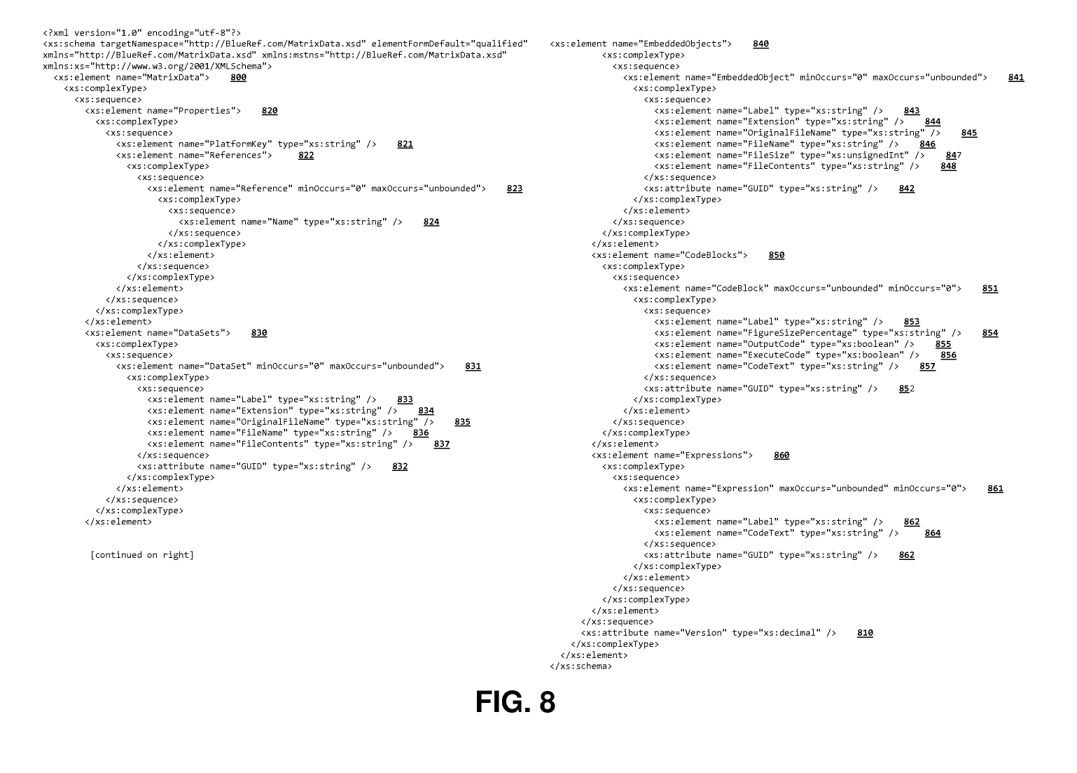

Those skilled in the art will recognize that data analysis parts can be enumerated as named part type elements rather than as collections of Parts with associated Type attributes as illustrated in FIG. 5, FIG. 6 and FIG. 7. The structure of an illustrative XML schema for defining the properties and content of such a data-analysis parts container is illustrated in FIG. 8, which includes a MatrixData element 800 for containing the Properties element 820 and the named part type elements including DataSets 830, EmbeddedObjects 840, CodeBlocks 850 and Expressions 860. The MatrixData element 800 is utilized to define and constrain properties of the data analysis container and to define and constrain data analysis parts.

The Properties element 820 is utilized to define and constrain the properties of its parent element MatrixData, 800. The Properties element 820 may have child elements PlatformKey 821, utilized to define the data-analysis platform associated with MatrixData, and References 822, utilized to define auxiliary entities needed to perform the data analysis such a libraries, packages and functions.

The DataSets element 830 is utilized to define and constrain the collection of data sets in the data-analysis parts container. A data set is typically associated with a specific data structure which has been saved to a file. DataSets 830 may contain zero or more DataSet 831, which may have child elements including but not limited the following: a Label 833 for defining the name of the data set; an Extension 834 for defining the file extension associated with the data set; an OriginalFileName 835 for defining the source file name associated with the data set; a FileName 836 for defining an alias for the source file associated with the data set; and FileContents 837 for defining the contents of the data set. Further, a DataSet 831 may have zero or more attributes including a globally unique ID (GUID) 832.

The EmbeddedObjects element 840 is used to define and constrain the collection of objects in the data-analysis container. An embedded object is typically serialized prior to use which corresponds to the process of saving an object onto a storage medium. EmbeddedObjects 840 may contain zero or more EmbeddedObject 841, which may have child elements including but not limited to the following: a Label 843 for defining the name of the embedded object; an Extension 844 for defining the file extension associated with the object; an OriginalFileName 845 for defining the source of the file associated with the object; a FileName 846 for defining an alias for the source file associated with the object; and FileContents 847 for defining the contents of the object. Further, an EmbeddedObject 841 may have zero or more attributes including a globally unique ID (GUID) 842.

It is to be understood that any type of non-textual data set or serialized object can be used within the present invention by appropriate binary to text encoding of the data set or serialized object to a text format consistent with XML use. Binary to text encoding approaches include but are not limited to the following: base64, uuencoding, quoted-printable, BinHex, Ascii85, yEnc, Radix-64, and Percent encoding.

The CodeBlocks element 850 is used to define and constrain the collection of code blocks in the data-analysis container. A code block typically consists of multiple lines of computer-readable code in the form of text. CodeBlocks 850 may contain zero or more CodeBlock elements, which may have child elements including but not limited to the following: a Label 853 for defining the name of the code block; a FigureSizePercentage 854 for defining the size of any graphic output resulting from executing the code block during data analysis; an OutputCode 855 for defining a Boolean value that determines whether display of the code block is suppressed during data analysis; an ExecuteCode 856 for defining a Boolean value that determines whether execution of the code block is suppressed during data analysis; and CodeText 857 for defining the contents of the code block. Further, a CodeBlock 851 may have zero or more attributes including a globally unique ID (GUID) 852.

The Expressions element 860 is used to define and constrain the collection of expressions in the data-analysis container. An expression typically consists of a single line of computer-readable code in the form of text. Expressions 860 may contain zero or more Expression 861, which may have child elements including but not limited to the following: a Label 863 for defining the name of the expression; and CodeText for defining the contents of the expression. Further, an Expression 861 may have zero or more attributes including a globally unique ID (GUID) 862.

The MatrixData element 800 and the CodeBlocks 850 and Expressions 860 elements are described in further detail in co-pending U.S. patent application entitled “Method and Apparatus for Data-Analysis in a Word Processor Application” which is expressly incorporated herein, in its entirety, by reference.

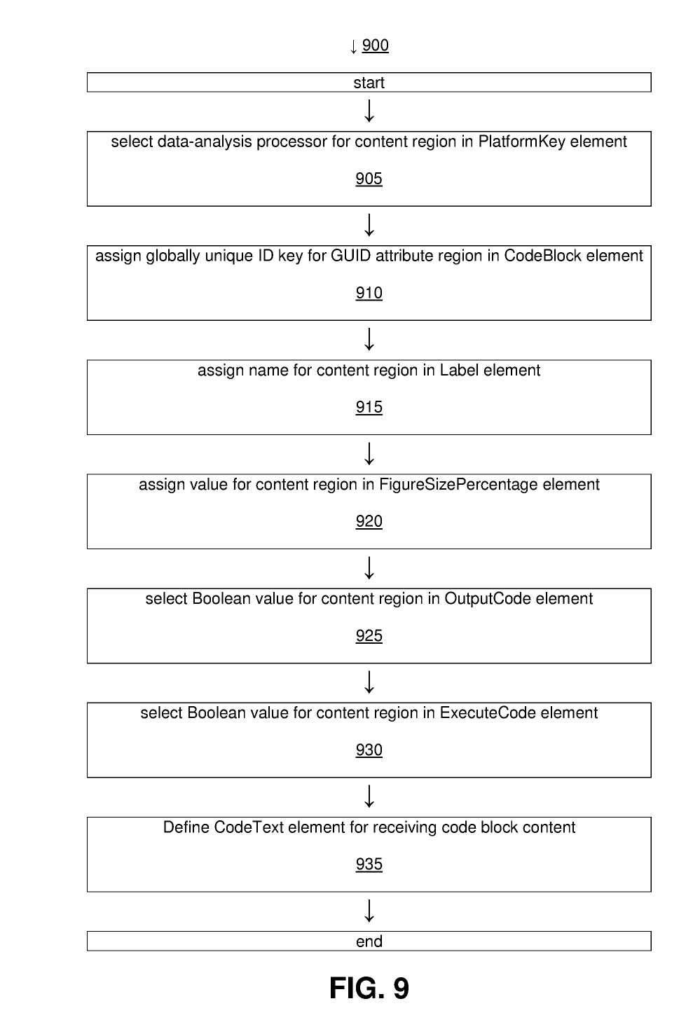

Referring now to FIG. 9 an exemplary routine 900 will be described illustrating a process for utilizing a schema for representing a computer-readable XML data structure for generating a data-analysis parts container comprising a data-analysis part for use in a word processor application. It should be appreciated that although the embodiments of the invention described herein are presented in the context of data-analysis in a word processor application, and specifically Microsoft Word, embodiments of the invention are contemplated with other application programs including but not limited to spreadsheet application programs, presentation application programs, drawing application programs, and database application programs.

When reading the discussion of the routines presented herein, it should be appreciated that the logical operations of various embodiments of the present invention are implemented (1) as a sequence of computer implemented acts or program modules 270 running on a computing system and/or (2) as interconnected machine logic circuits or circuit modules within the computing system. The implementation is a matter of choice dependent on the performance requirements of the computing system implementing the invention. Accordingly, the logical operation illustrated in FIG. 9, and making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein.

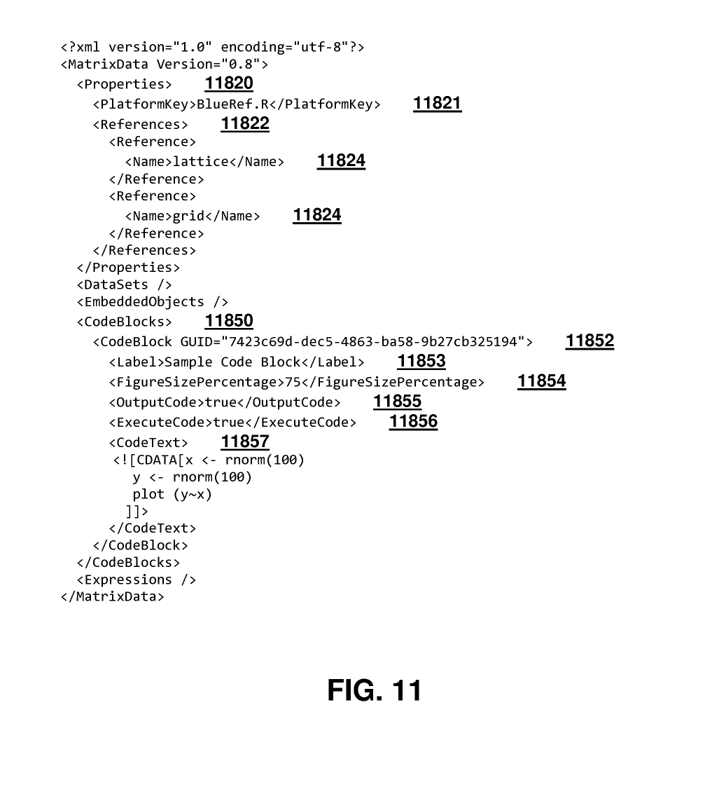

Referring now to FIG. 9, the routine 900 begins at operation 905, wherein the PlatformKey element 821 receives a name for the data analysis platform selected from a selection list. In particular, a user may select a data-analysis processor name from a dropdown box containing a list of options displayed in a data-analysis action pane, which are described in further detail in co-pending U.S. patent application entitled “Method and Apparatus for Managing Data-Analysis Parts in a Word Processor Application” which is expressly incorporated herein, in its entirety, by reference. The routine continues from operation 905 to operation 910, wherein the CodeBlock element 851 receives a globally unique identification key (GUID) attribute 852. An example of the utilization of the PlatformKey element and the CodeBlock element GUID attribute in a schema will be described below with respect to FIG. 11.

The routine 900 continues from operation 910 to operation 915, wherein the Label element 853 receives insertion text for a name identifying the code block. In particular, a user may insert a text string within the placeholder element 853 to provide an identifying label on the code block data-analysis part. For instance, the label may read “ANOVA Analysis.” The routine 900 continues from operation 915 to operation 920, wherein the FigureSizePercentage element 854 receives a numerical value, which allows a user to insert a value between 0 and 100 to indicate to what percent of the word processing document margin to adjust the size of any graphics outputted as a result of executing the data analysis called for in the code block.

The routine 900 continues from operation 920 to operation 925, wherein the OutputCode element 855 Boolean value is selected in the schema for the content region. In particular, a user may select one of two mutually exclusive properties (true or false) to indicate whether the content of the CodeText element 857 should be suppressed in the output during performance of the data analysis. The routine 900 continues from operation 925 at operation 930, wherein the ExecuteCode element 856 Boolean value is selected in the schema for the content region. In particular, a user may select one of two mutually exclusive properties (true or false) to indicate whether the content of the CodeText element 857 should be suppressed in code block execution during data analysis.

The routine 900 continues from operation 930 to operation 935, wherein the CodeText element 857 receives insertion text corresponding to instructions used by the data-analysis platform for data analysis. In particular, a user may insert a text string within the placeholder element 857. It should be understood that insertion of a text string may be achieved through direct actions of the user or may be achieved through actions of an auxiliary application program. The routine 900 then ends.

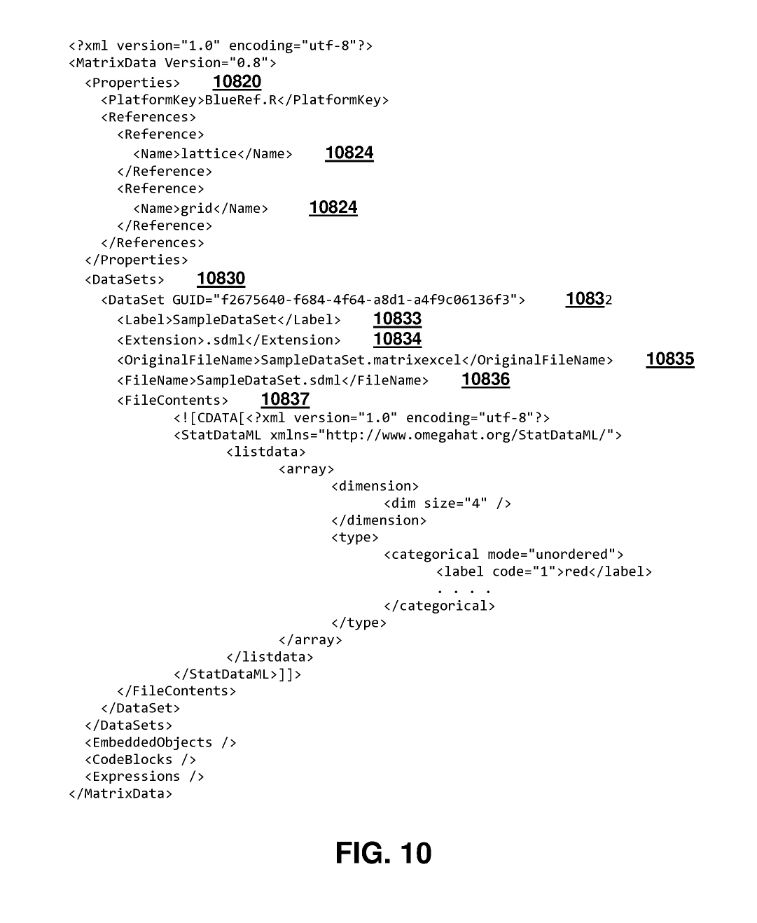

FIG. 10 and FIG. 11 show illustrative XML documents conforming to the schema for defining data-analysis parts container according to illustrative embodiments of the invention. In particular, FIG. 10 and FIG. 11 show illustrative instances of an XML document consistent with structure of the schema illustrated in FIG. 7 and consistent with the W3C Schema defined in FIG. 8 for use in an electronic document created by a word processor application.

Turning now to FIG. 10, an XML data structure 10000 is shown for defining a data-analysis part of the type DataSets 830. The data structure 10000 includes assigned Properties 10820 of PlatformKey 10821 with label reading “BlueRef.R” 10821 for assignment of the data-analysis processor and a pair of assigned data-analysis processor package references with labels “lattice” 10824 and “grid” 10824. The XML data structure 10000 defines a data-analysis part DataSets 10830 and includes a DataSet with an assigned GUID 10832, a Label 10833 reading “SampleDataSet,” an Extension 10834 reading “.sdml,” an OriginalFileName 10835 reading “SampleDataSet.matrixexcel,” a FileName 10836 reading “SampleDataSet.sdml,” and a FileContents 10837 reading an XML CDATA section containing the data set contents.

In this illustrative example, the FileContents 10837 are inserted in an XML CDATA section as a serialized XML data structure in the form of a string in conformance with the Statistics Date Markup Language schema that may be found at http://www.omegahat.org/StatDataML. This schema provides a way to serialize many common data structures such as vectors, arrays, data frames, lists, etc. as XML data structures. It is to be understood that the invention may be used with any data structure, format or object, which may be serialized to text employing the many serialization and/or encoding techniques available to achieve such ends.

Turning now to FIG. 11, an XML data structure 11000 is shown for defining a data analysis part of the type CodeBlock 851. The data structure 11000 includes assigned Properties 11820 of PlatformKey 11821 with label reading “BlueRef.R” 11821 for assignment of the data-analysis processor and a pair of assigned data-analysis processor package references with labels “lattice” 11824 and “grid” 11824. The XML data structure 11000 defines a data-analysis part CodeBlocks 11850 and includes a CodeBlock with and assigned GUID 11852, a Label 11853 reading “Sample Code Block,” a FigureSizePercentage 11854 reading “75,” an OutputCode 11855 reading “true,” an ExecuteCode 11856 reading “true,” and a CodeText 11857 reading three lines of instructions readable by a computer system of the present invention employing the assigned data-analysis processor.

Exemplary embodiments of the present invention may be implemented by communications between different software objects in an object-oriented programming environment. For purposes of the following description of example embodiments, it is useful to briefly to describe components of an object-oriented programming environment.

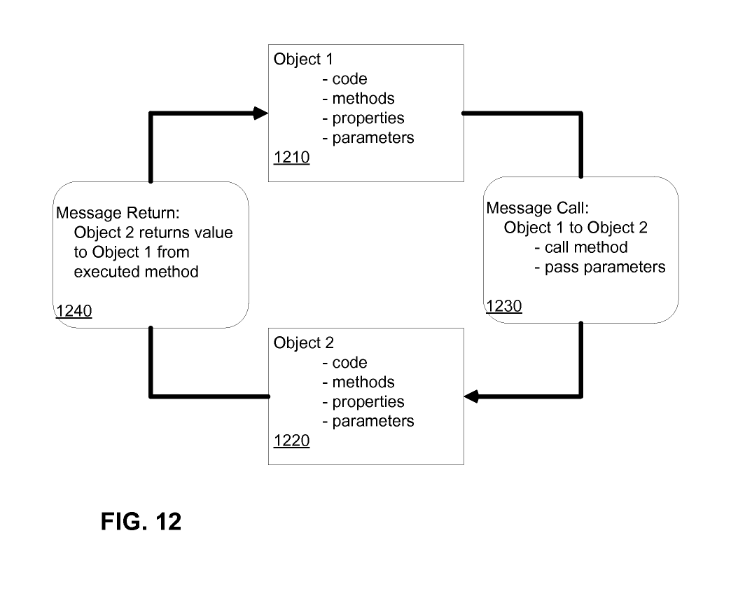

Referring now to FIG. 12, a simplified block diagram illustrating interaction between software objects according to an object-oriented programming model is shown. According to an object-oriented programming environment, a first object 1210 can include software code, executable methods, properties, and parameters. Similarly, a second object 1220 can also include software code, executable methods, properties, and parameters.

A first object 1210 can communicate with a second object 1220 to obtain information or functionality from the second object 1220 by calling the second object 1220 via a message call 1230. As is well know to those skilled in the art of object-oriented programming environment, the first object 1210 can communicate with the second object 1220 via application programming interfaces (API) that allow two disparate software objects 1210, 1220 to communicate with each other in order to obtain information and functionality from each other.

For example, if the first object 1210 requires the functionality provided by a method contained in the second object 1220, the first object 1210 can pass a message call 1230 to the second object 1220 in which the first object identifies the required method and in which the first object passes any required parameters to the second object required by the second object for operating the identified method. Once the second object 1220 receives the call from the first object 1210, second object 1220 executes the called method based on the provided parameters and sends a return message 1240 containing a value obtained from the executed method back to the first object 1210.

Referring now to FIG. 2, an example block diagram is provided illustrating interaction between a data-analysis template 220, comprising a word processor document 230 and a data-analysis parts container 260, wherein the data-analysis parts container is maintained as a string in the separated data content 250 portion of the word processor document 230. FIG. 2 also shows program modules 270 that access the resources of the data-analysis parts container 260. Word processor document 230 and data-analysis template 220 can be saved according to a variety of different file formats and according to the native format of the word processor application 210 with which the data-analysis template 220 is created.

Various data-analysis parts 262 can be included in the data-analysis parts container 260 using, for example, the word processor application 210 in conjunction with program modules 270. According to example embodiments, an object-oriented programming model is provided to allow program modules 270 to access and/or manipulate data-analysis parts 262 embedded in data-analysis parts container 260 and/or the data analysis parts container 260 embedded in the data content 250 via a set of application programming interfaces or object-oriented message calls either directly through one or more application programming interfaces or programmatically through other software application programs written according to a variety of programming languages such as, for example C, C++, C#, Visual Basic, and the like.

In some embodiments, program modules 270 may be plug-ins or add-ins to the word processor application 210, or a standalone application that can be used to access and/or manipulate data-analysis parts in a data-analysis template 220 or in a data-analysis parts container 260. For example, a program module 270 may be used to communicate a data-analysis parts container 260 in a word processor application to a data-analysis processor to generate a data-analysis results collection, or can be used to edit a data-analysis part 262 using a standalone application like MatrixStudio developed by Blue Reference Corporation. These and other embodiments of the programmable object model are described in further detail in co-pending U.S. patent applications “Object-Oriented Framework for Data-Analysis Having Pluggable Platform Runtimes and Export Services” and “Methods and Apparatus for Data Analysis in a Word Processor Application” which are expressly incorporated herein, in its entirety, by reference.

The following is a description of objects and associated properties comprising application programming interfaces (API) or object-oriented message calls that provide access to the resources in the data-analysis parts container. Following each of the objects set out below is a description of the operation, properties and methods of the object.

MatrixDocument Object—This object is used to encapsulate a disk file that comprises the MatrixData object. This object extends the MatrixData object and implements IDocument.

The following are properties and methods of the object.
FilePath Property [Return Type String]—returns the path of the file on disk.
Filename Property [Return Type String]—returns the name of the file, for example “Temp.matrix.”
Fileinfo Property [Return Type FileInfo]—Returns a .NET FileInfo object about the file size, for example, size, properties, etc.
DocumentSaved Property [Return Type Bool]—Returns whether the file has been saved to disk.
NewDocument Method—Creates a new document.
OpenDocument Method—Opens a document from a specified file path.
CloseDocument Method—Closes the document.
SaveDocument Method—Saves the document to its current file path.
SaveDocumentAs Method—Saves the document to a new specified file path.
ImportMatrixData Method—Imports the contents of a specified MatrixData object into the current object.

MatrixData Object—Object used to encapsulate a data analysis parts container. This object has no public methods; all methods listed are protected, such that they can be used by objects that inherit MatrixData as its base.

The following are properties and methods of the object.
Properties Property [Return Type Properties]—Returns the internal Properties object.
DataSets Property [Return Type DataSets]—Returns the internal DataSets object.
EmbeddedObjects Property [Return Type Embedded Objects]—Returns the internal EmbeddedObjects object.
CodeBlocks Property [Return Type CodeBlocks]—Returns the internal CodeBlocks object.
Expressions Property [Return Type Expressions]—Returns the internal Expressions object.
XMLData Property [Return Type String]—Returns the XML-formatted string comprising a serialization of the MatrixData object.
ImportData Method—Import the contents of the specified objects (Properties, DataSets, etc.) into the current object.
CreateNewObject Method—Initializes the internal objects.
LoadDataFromXML Method—Loads the contents of the object from a specified XML-formatted string.
LoadDataFromFile Method—Loads the contents of the object from a specified file path to a file that contains an XML-formatted string serialization of an MatrixData object.
SaveDataToFile Method—Saves the contents of the object as an XML-formatted string to a specified file path.

Properties Object—Object used to encapsulate the properties for the MatrixData object. It is to be noted that this is not a collection.

The following are properties and methods of the object.
PlatformKey Property [Return Type String]—Returns the data-analysis processor runtime key associated with the MatrixData object.
References Property [Return Type References]—Returns the internal References object.
ImportData Method—Imports the contents of the a specified Properties object into the current object.
SerializeXMLData Method—Serializes the object contents using a specified XMLTextWriter object.

References Object—Object used to encapsulate the collection of Reference objects contained in the properties of a MatrixData object. This object inherits from CollectionBase and comprises a collection of Reference objects.

The following are properties and methods of the object.
Add Method [Return Type Reference]—Returns the new object added to the collection.
AddRange Method—Adds the contents of a specified References collection to the collection.
Clone Method—[Return Type References]—Returns a new deep copy of the object.
Replace Method—Replaces the current object collection contents with the contents of a specified References collection.
Remove Method—Removes as specified collection object from the collection.
FindItem Method [Return Type Reference] Returns and item in the collection.
SerializeXMLData Method—Serializes the object contents using a specified XMLTextWriter object.

Reference Object—Object used to encapsulate a reference.

The following are properties and methods of the object.
Name Property [Return Type String]—Returns the name of the reference.
Clone Method [Return Type Reference]—Returns a new deep copy of the object.
SerializeXMLData Method—Serializes the object contents using a specified XMLTextWriter object.
DataSets Object—Object used to encapsulate the collection of DataSet objects contained in a MatrixData object. This object inherits from DataObjectItems (which itself inherits from CollectionBase) and comprises a collection of DataSet objects.

The following are properties and methods of the object.
Add Method [Return Type DataSet]—Returns the new object added to the collection.
CanMoveUp Method [Return Type Boolean]—Returns whether a specified collection object can be moved towards the front of the collection.
CanMoveDown Method [Return Type Boolean]—Returns whether a specified collection object can be moved towards the back of the collection.
MoveUp Method—Moves a specified collection object one place backwards within the collection ordering.
MoveDown Method—Moves a specified collection object one place forwards within the collection ordering.
Remove Method—Removes a specified collection object from the collection.
FindItem Method [Return Type DataSet]—Returns an item in the collection.
UpdateIndices Method—Updates the Index property of each collection object in accordance with the current collection order.
SerializeXMLData Method—Serializes the object contents using a specified XMLTextWriter object.

DataSet Object—Object used to encapsulate a data set. The data set contains an embedded file comprising a data set in SDML format; this embedded file can be an SDML file from disk or an SDML file extracted from a different source (such as a MatrixExcel document). Object implements IDataItem interface.

The following are properties and methods of the object.
Type Property [Return Type DataObjectItemType]—Returns the type of the DataItem from an enumerated list (DataSet, EmbeddedObject).
Index Property [Return Type Integer]—Returns the index of the object.
GUID Property [Return Type String]—Returns the GUID of the object.
Label Property [Return Type String]—Returns the label of the object.
FileName Property [Return Type String]—Returns the name of the embedded file, for example “Test.sdml.”
OriginalFileName Property [Return Type String]—Returns the name of the file from which the embedded file originates, for example “Test.matrixexcel.”
Extension Property [Return Type String]—Returns the file extension of the embedded file, for example “.sdml.”
FileContents Property [Return Type String]—Returns the contents of the embedded file as a string.
StatData Property [Return Type StatData]—Returns the contents of the embedded file as a StatData object.
Clone Method—Returns a new deep copy of the object.
ImportFileContents Method—Embeds the contents of a specified file into the object; this sets all of the associated embedded file properties.
ExportFileContents Method—Exports the contents of the embedded file to a specified file path.
UpdateGUID Method—Creates a new GUID for the object.
SerializeXMLData Method—Serializes the object contents using a specified XMLTextWriter object.

EmbeddedObjects Object—Object used to encapsulate the collection of EmbeddedObject objects contained in a MatrixData object. This object inherits from DataObjectItems (which itself inherits from CollectionBase) and comprises a collection of EmbeddedObject objects.

The following are properties and methods of the object.
Add Method [Return Type Embedded Object]—Returns the new object added to the collection.
CanMoveUp Method [Return Type Boolean]—Returns whether a specified collection object can be moved towards the front of the collection.
CanMoveDown Method [Return Type Boolean]—Returns whether a specified collection object can be moved towards the back of the collection.
MoveUp Method—Moves a specified collection object one place backwards within the collection ordering.
MoveDown Method—Moves a specified collection object one place forwards within the collection ordering.
Remove Method—Removes a specified collection object from the collection.
FindItem Method [Return Type Embedded Object]—Returns an item in the collection.
UpdateIndices Method—Updates the Index property of each collection object in accordance with the current collection order.
SerializeXMLData Method—Serializes the object contents using a specified XMLTextWriter object.

EmbeddedObject Object—Object used to encapsulate an embedded object. The embedded object contains an embedded file comprising a data file stored in binary format; this embedded file is loaded into the platform runtime engine prior to runtime execution. This object implements ICodeItem.

The following are properties and methods of the object.
Type Property [Return Type DataObjectItemType]—Returns the type of the DataItem from an enumerated list (DataSet, EmbeddedObject).
Index Property [Return Type Integer]—Returns the index of the object.
GUID Property [Return Type String]—Returns the GUID of the object.
Label Property [Return Type String]—Returns the label of the object.
FileName Property [Return Type String]—Returns the name of the embedded file, for example “Test.sdml.”
OriginalFileName Property [Return Type String]—Returns the name of the file from which the embedded file originates, for example “Test.matrixexcel.”
Extension Property [Return Type String]—Returns the file extension of the embedded file, for example “.sdml.”
Clone Method—Returns a new deep copy of the object.
ImportFileContents Method—Embeds the contents of a specified file into the object; this sets all of the associated embedded file properties.
ExportFileContents Method—Exports the contents of the embedded file to a specified file path.
UpdateGUID Method—Creates a new GUID for the object.
SerializeXMLData Method—Serializes the object contents using a specified XMLTextWriter object.

CodeBlocks Object—Object used to encapsulate the collection of CodeBlock objects contained in a MatrixData object. This object inherits from CodeItems (which itself inherits from CollectionBase) and comprises a collection of CodeBlock objects.

The following are properties and methods of the object.
Add Method [Return Type CodeBlock]—Returns the new object added to the collection.
AddRange Method—Adds the contents of a specified CodeBlocks collection to the collection.
UpdateIndices Method—Updates the Index property of each collection object in accordance with the current collection order.
UpdateContents Method—Replaces the current object collection contents with the contents of a specified CodeBlocks collection.
Remove Method—Removes a specified collection object from the collection.
FindItem Method [Return Type CodeBlock]—Returns and item in the collection.
CanMoveUp Method [Return Type Boolean]—Returns whether a specified collection object can be moved towards the front of the collection.
CanMoveDown Method [Return Type Boolean]—Returns whether a specified collection object can be moved towards the back of the collection.
MoveUp Method—Moves a specified collection object one place backwards within the collection ordering.
MoveDown Method—Moves a specified collection object one place forwards within the collection ordering.
FindItemByLabel Method [Return Type CodeBlock]—Returns an item in the collection using a specified label.
SerializeXMLData Method—Serializes the object contents using a specified XMLTextWriter object.
CodeBlock Object—Object used to encapsulate a code block. This object implements ICodeItem.

The following are properties and methods of the object.
Type Property [Return Type CodeItemType]—Returns the type of the CodeItem from an enumerated list (CodeBlock, Expression).
MultiLlne Property [Return Type Boolean]—Returns whether the CodeItem spans multiple lines (for CodeBlocks, this is always True; for Expressions, this is always False).
GUID Property [Return Type String]—Returns the GUID of the object.
CodeText Property [Return Type String]—Returns the code text of the object.
Label Property [Return Type String]—Returns the label of the object.
OutputCode Property [Return Type Boolean]—Returns whether the code is outputted to the data analysis results document for this code item.
ExecuteCode Property [Return Type Boolean]—Returns whether the code is executed for this code item.
FigureSizePercentage Property [Return Type Short]—Returns the percentage of the total page width that figures resulting from the code item should be sized to.
Index Property [Return Type Integer]—Returns the index of the object.
ImportData Method—Replaces the contents of the object with the contents of a specified CodeBlock.
Clone Method [Return Type CodeBlock]—Returns a new deep copy of the object.
UpdateGUID Method—Creates a new GUID for the object.
SerializeXMLData Method—Serializes the object contents using a specified XMLTextWriter object.

Expressions Object—Object used to encapsulate the collection of Expression objects contained in a MatrixData object. This object inherits from CodeItems (which itself inherits from CollectionBase) and comprises a collection of Expression objects.

The following are properties and methods of the object.
Add Method [Return Type Expression]—Returns the new object added to the collection.
AddRange Method—Adds the contents of a specified CodeBlocks collection to the collection.
UpdateIndices Method—Updates the Index property of each collection object in accordance with the current collection order.
UpdateContents Method—Replaces the current object collection contents with the contents of a specified CodeBlocks collection.
Remove Method—Removes a specified collection object from the collection.
FindItem Method [Return Type Expression]—Returns and item in the collection.
CanMoveUp Method [Return Type Boolean]—Returns whether a specified collection object can be moved towards the front of the collection.
CanMoveDown Method [Return Type Boolean]—Returns whether a specified collection object can be moved towards the back of the collection.
MoveUp Method—Moves a specified collection object one place backwards within the collection ordering.
MoveDown Method—Moves a specified collection object one place forwards within the collection ordering.
FindItemByLabel Method [Return Type Expression]—Returns an item in the collection using a specified label.
SerializeXMLData Method—Serializes the object contents using a specified XMLTextWriter object.

Expression Object—Object used to encapsulate a single-line expression. This object implements ICodeItem.

The following are properties and methods of the object.
Type Property [Return Type CodeItemType]—Returns the type of the CodeItem from an enumerated list (CodeBlock, Expression).
MultiLIne Property [Return Type Boolean]—Returns whether the CodeItem spans multiple lines (for CodeBlocks, this is always True; for Expressions, this is always False).
GUID Property [Return Type String]—Returns the GUID of the object.
CodeText Property [Return Type String]—Returns the code text of the object.
Label Property [Return Type String]—Returns the label of the object.
OutputCode Property [Return Type Boolean]—Returns whether the code is outputted to the data analysis results document for this code item.
ExecuteCode Property [Return Type Boolean]—Returns whether the code is executed for this code item.
FigureSizePercentage Property [Return Type Short]—Returns the percentage of the total page width that figures resulting from the code item should be sized to.
Index Property [Return Type Integer]—Returns the index of the object.
Clone Method [Return Type Expression]—Returns a new deep copy of the object.
UpdateGUID Method—Creates a new GUID for the object.
SerializeXMLData Method—Serializes the object contents using a specified XMLTextWriter object.

The example object model disclosed above allows users to access and manipulate the resources of a data-analysis parts container and to access and manipulate a data-analysis parts container. For example, an example code section, shown in pseudocode and C# code, illustrates the use of the programmable object model to access the resources of a data-analysis container as a component of a data-analysis template, serialized as a .matrixdata file, and add a new code block object using the following steps:

Psuedocode representation of the procedure:
Instantiate a MatrixDocument object using an existing file path
Instantiate a new CodeBlock object using the Add method of the MatrixDocument object's CodeBlocks collection
Set the CodeText property of the new CodeBlock object to “print(‘my new codeblock“\’)”
Save the MatrixDocument object

Implementation as C# code:
using BlueRef.Inference.Data.Matrix;
MatrixDocument myMatrixDocument=new MatrixDocument(“c:\\Temp\\Sample.matrix”);
CodeBlock myNewCodeBlock=myMatrixDocument.CodeBlocks.Add( );
myNewCodeBlock.CodeText=“print(‘my new codeblock’)”;
myMatrixDocument.SaveDocument( );

In another example of the programmable object model, a new .matrixdata file is created and a data set is added using an existing .sdml file. Note that when the data set is added (using the specified data set file path), the contents of the data set file are embedded into the DataSet object.

Pseudocode representation of the procedure:
Instantiate a new MatrixDocument object
Instantiate a new DataSet object using the Add method of the MatrixDocument object's DataSets collection in conjunction with a specified data set file path
Save the new MatrixDocument object to disk using a specified file path

Implementation as C# code:
using BlueRef.Inference.Data.Matrix;
MatrixDocument myNewMatrixDocument=new MatrixDocument( );
DataSet myNewDataSet=myNewMatrixDocument.DataSets.Add(“c:\\Temp\\SampleDataSet.sdml”);
myNewMatrixDocument.SaveDocumentAs(“c:\\Temp\\NewMatrixDocument.matrix”);

One embodiment of the present invention entails a computer-readable medium comprising a data-analysis template for use in data analysis in a word processor application, the data-analysis template comprising: a serialized word processor document, wherein presentation content and data content may be separated; a serialized data-analysis parts container; and program modules for communicating a data-analysis part between the word processor document and the data-analysis parts container. Referring to FIG. 2, a data-analysis template 220 is used by a word processor application 210 and is comprised of a word processor document 230 and a data-analysis parts container 260. Data-analysis templates may be used to perform data analysis to generate a data-analysis results collection within the familiar environment of a word processor application employing data-analysis parts and one of a selection of data-analysis processors. Illustrative data-analysis templates for generating data-analysis results include but are not limited to the following: data-analysis templates for assembly as electronic laboratory notebooks (for example: templates in chemistry discovery, biology discovery, chemical development, bioprocess development, formulation development, analytical development and clinical development); data-analysis templates for life sciences (for example: genomic analysis, microarray analysis, Taqman analysis, cheminformatics analysis, clinical trial design and analysis, biostatics analysis, health services and outcomes analysis, process analytical technology analysis); data-analysis templates for economics and finance (for example: loan portfolio valuation analysis, portfolio optimization analysis, risk management analysis, trading strategies analysis, consumer behavior analysis); data-analysis templates for manufacturing (for example: design and analysis of experiments, reliability and life expectancy analysis, field failure analysis, supply chain optimization analysis, demand forecasting optimization analysis, statistical process control analysis, six sigma analysis); and data-analysis templates for business performance analysis (for example: customer churn analysis, fraud detection analysis, data quality management analysis, marketing campaign analysis, customer behavior analysis). Implementation of data-analysis templates are described in further detail in co-pending U.S. patent application entitled “Method and Apparatus for Data Analysis in a Word Processing Application” which is expressly incorporated herein, in its entirety, by reference.

As illustrated earlier, communicating a data-analysis part 262 between the word processor document 230 and the data-analysis parts container 260 is facilitated by the use of program modules 270. Implementation of such program modules may be through the use of smart document technology, which provides an architecture to build context-sensitive data-analysis templates. Smart document solutions associate an electronic document like a word processor document 230 with an XML schema, so that presentation content 240 like a paragraph of text may be distinguished from data content 250 like a string of text corresponding to a data-analysis part 262. It is important to note that the base functionality of the word processor application is retained in a smart document solution. Smart document solutions allows programmatic customization for searching within and operating on extensible markup language (XML) nodes within a data-analysis template, which is comprised of a data-analysis parts container. Data-analysis templates may be documents in a word processor application or may be files that can be opened by a word processor application such as Word developed by Microsoft Corporation.

Smart document solutions may be created using many modern programming systems such as Microsoft Visual BasicT™ 6.0, Microsoft Visual Basic .NET™, Microsoft Visual C#™.NET, Microsoft Visual J#™ or Microsoft Visual C++™ development systems. Creation of smart document solutions may be assisted by use of software development tools such as Visual Studio Tools for Office developed by Microsoft Corporation. Smart document solutions may be deployed over a corporate intranet, over the Internet, or through Web sites. Further descriptions and details for the creation of smart document solutions may be found in the book by Eric Carter and Eric Lippert entitled “Visual Studio Tools for Office: Using C# with Excel, Word, Outlook, and Infopath,” Addison Wesley Professional, Microsoft .NET Development Series, 2006.

A user may create a smart document solution as a dynamic linked library (DLL) or as an XML file. An example of the data-analysis template development cycle using the DLL approach may be as follows:
1. Create a computer-readable XML data structure for a data-analysis parts container. Such a data structure comprises an XML file that may be created using an XML editor such as XML Spy developed by Altova Corporation or a text editor such as Notepad developed by Microsoft Corporation. The XML data structure may be defined by an XML schema.
2. Attach the XML data structure for the data-analysis parts container to a word processor document. Associate XML elements with the portions of the document that will have smart document actions associated with them. The result is a data-analysis template. Note that the data-analysis template may be comprised of at least one word processor file or a plurality of word processor and data files, optionally in a compressed format. A data-analysis template may be stored in a variety of possible file formats including but not limited to the following: standard binary Word (*.doc); extensible markup language file (*.xml); Word document template (*.dot); Word markup language (*.docx); Word markup language macro-enabled document (*.docm); Word markup language document template (*.dotx); and Word markup language macro-enabled document template (*.dotm).
3. Use the smart document API to write code that displays controls in the Document Actions task pane. Write code that takes action when the user interacts with the controls. A preferred embodiment of the present invention employs an object-oriented framework of reusable objects to simplify writing this code and reduce the amount of code that has to be written. The details of this object-oriented framework are described in co-pending U.S. patent application entitled “Object-Oriented Framework for Data-Analysis Having Pluggable Platform Runtimes and Export Services,” the disclosure of which is incorporated herein, in its entirety.
4. Store the smart document code and all of the files used by the smart document on a local machine, on a file server or on a Web server such that a users can access it.
5. Create an XML expansion pack manifest file that references all of the files used by the smart document solution. This step may not be required when using Visual Studio Tools for Office.
6. Use the user interface to reference the XML expansion pack manifest file and attach the solution to the document. This step also may not be required when using Visual Studio Tools for Office.
7. Distribute the document as a data-analysis template. When a user opens the data-analysis template in the word processor application, the data-analysis template and any supporting files used by the data-analysis template may be used locally or downloaded and registered locally on the user's computer without any user intervention

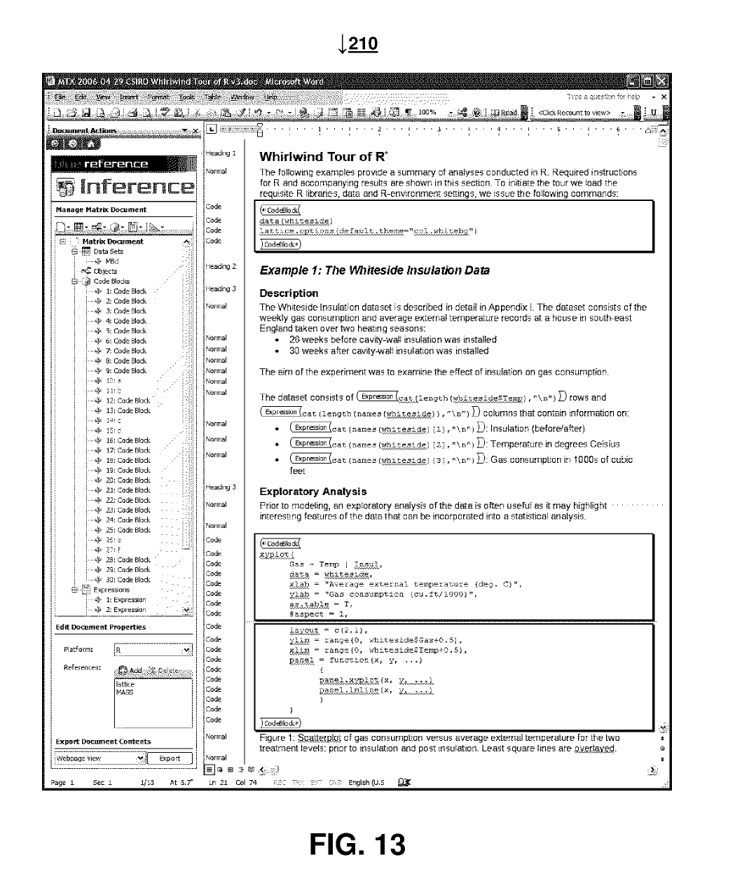

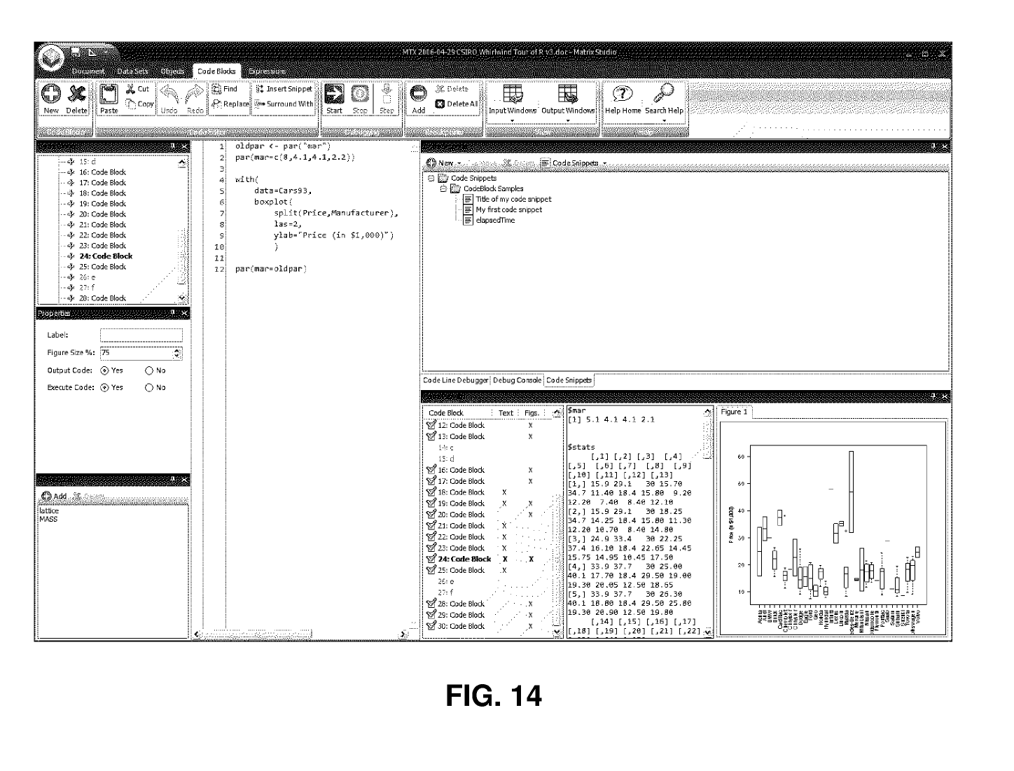

In some embodiments of the present invention, program modules 270 can be a plug-in to the word processor application 210. FIG. 13 illustrates a screenshot of an exemplary word processor application using a data-analysis template 220. In other embodiments of the present invention, program modules 270 can be a standalone application that can be used to access and/or manipulate data-analysis parts in a data-analysis template 220 or in a data-analysis parts container 260. FIG. 14 illustrates a screenshot of an exemplary integrated development environment for development of data-analysis parts in a data-analysis parts container using an embodiment of the programmable object model of the present invention.

Although the forgoing text sets forth a detailed description of numerous different embodiments, it should be understood that the scope of the patent is defined by the words in the claims set forth at the end of the patent. The detailed description is to be construed as exemplary only and does not describe every possible embodiment because describing every possible embodiment would be impractical, if not impossible. Numerous alternative embodiments could be implemented, using either current technology or technology developed after filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and not limiting upon the scope of the claims.

What is claimed is:

1. A computer-readable extensible markup language data structure comprising structural elements for defining a data-analysis parts container in a data-analysis template comprising a word processor document, the computer-readable data structure comprising:
at least one properties element for receiving properties associated with the data-analysis parts container; and
at least one data-analysis parts element for receiving data-analysis parts,
wherein the at least one properties element and the at least one data-analysis parts element define the data-analysis parts container in the data-analysis template comprising a word processor document.

2. The computer-readable extensible markup language data structure of claim 1, wherein the properties element comprises at least one attribute for identifying a data-analysis processor.

3. The computer-readable extensible markup language data structure of claim 1, wherein the data-analysis parts element comprises at least one element comprising at least one attribute for defining a data-analysis part wherein the part is selected from a group of data-analysis part types comprising: a data set; an object; a code block; an expression; a chemical structure; a chemical reaction structure; a reaction table; a formulations table; a process pathway; a spectrum; and a chromatogram.

4. The computer-readable extensible markup language data structure of claim 1, wherein the data-analysis parts element comprises at least one element selected from a group of elements, the group of elements comprising:
an element for defining a data-analysis part associated with a data set;
an element for defining a data-analysis part associated with an object;
an element for defining a data-analysis part associated with a code block;
an element for defining a data-analysis part associated with an expression;
an element for defining a data-analysis part associated with a chemical structure;
an element for defining a data-analysis part associated with a chemical reaction structure;
an element for defining a data-analysis part associated with a reaction table;
an element for defining a data-analysis part associated with a formulations table;
an element for defining a data-analysis part associated with a process pathway;
an element for defining a data-analysis part associated with a spectrum; and
an element for defining a data-analysis part associated with a chromatogram.

5. A computer-implemented method for utilizing a computer-readable extensible markup language data structure comprising structural elements for defining a data-analysis parts container in a data-analysis template comprising a word processor document, the method comprising:
defining at least one properties element for receiving properties associated with the data-analysis parts container; and
defining at least one data-analysis parts element for receiving data-analysis parts,
wherein the at least one properties element and the at least one data-analysis parts element define the data-analysis parts container in the data-analysis template comprising a word processor document.

6. The computer-implemented method of claim 5, wherein defining the at least one properties element comprises assigning to the properties element an attribute identifying a data-analysis processor.

7. The computer-implemented method of claim 5, wherein defining the at least one data-analysis parts element comprises assigning to the parts element at least one attribute defining a data-analysis part wherein the part is selected from a group of data-analysis part types comprising: a data set; an object; a code block; an expression; a chemical structure; a chemical reaction structure; a reaction table; a formulations table; a process pathway; a spectrum; and a chromatogram.

8. The computer-implemented method of claim 5, wherein defining the at least one data-analysis parts element comprises assigning at least one element selected from a group of elements, the group of elements comprising:
an element for defining a data-analysis part associated with a data set;
an element for defining a data-analysis part associated with an object;
an element for defining a data-analysis part associated with a code block;
an element for defining a data-analysis part associated with an expression;
an element for defining a data-analysis part associated with a chemical structure;
an element for defining a data-analysis part associated with a chemical reaction structure;
an element for defining a data-analysis part associated with a reaction table;
an element for defining a data-analysis part associated with a formulations table;
an element for defining a data-analysis part associated with a process pathway;
an element for defining a data-analysis part associated with a spectrum; and
an element for defining a data-analysis part associated with a chromatogram.

9. A computer-readable medium comprising computer-readable instructions, which when executed on a computer perform a method for utilizing a computer-readable extensible markup language data structure comprising structural elements for defining a data-analysis parts container in a data-analysis template comprising a word processor document, the method comprising:
defining at least one properties element for receiving properties associated with the data-analysis parts container; and
defining at least one data-analysis parts element for receiving data-analysis parts,
wherein the at least one properties element and the at least one data-analysis parts element define the data-analysis parts container in the data-analysis template comprising a word processor document.

10. The computer-readable medium of claim 9, wherein defining the at least one properties element comprises assigning to the properties element an attribute identifying a data-analysis processor.

11. The computer-readable medium of claim 9, wherein defining the at least one data-analysis parts element comprises assigning to the parts element an attribute defining a data-analysis part wherein the part is selected from a group of data-analysis part types comprising: a data set; an object; a code block; an expression; a chemical structure; a chemical reaction structure; a reaction table; a formulations table; a process pathway; a spectrum; and a chromatogram.

12. The computer-readable medium of claim 9, wherein defining a data-analysis parts element comprises assigning at least one element selected from a group of elements, the group of elements comprising:
an element for defining a data-analysis part associated with a data set;
an element for defining a data-analysis part associated with an object;
an element for defining a data-analysis part associated with a code block;
an element for defining a data-analysis part associated with an expression;
an element for defining a data-analysis part associated with a chemical structure;
an element for defining a data-analysis part associated with a chemical reaction structure;
an element for defining a data-analysis part associated with a reaction table;
an element for defining a data-analysis part associated with a formulations table;
an element for defining a data-analysis part associated with a process pathway;
an element for defining a data-analysis part associated with a spectrum; and
an element for defining a data-analysis part associated with a chromatogram.

13. A programmable object model for accessing the resources of a data-analysis parts container comprising a computer-readable extensible markup language data structure, the model comprising:
an application programming interface for allowing a user to programmatically access resources defined in the computer-readable extensible markup language data structure defining a data-analysis parts container;
said application programming interface comprising at lease one message call for requesting association of one or more XML-defined resources to a data-analysis parts container object; and
said application programming interface operative to receive at least one return value from the data-analysis parts container object responsive to association of the one or more XML-defined resources to the data-analysis parts container object.

14. The programmable object model of claim 13, wherein the data-analysis parts container is a component of a data-analysis template comprising a word processor document.

15. The programmable object model of claim 14, wherein the word processor document is generated using Word developed by Microsoft Corporation.

16. A computer-readable medium having computer-executable instruction for performing steps comprising:
calling a data-analysis parts container via an object-oriented message call;
accessing an object property or method on the data-analysis parts container, the object property or method being associated with a resource defined in the data-analysis parts container; and
in response to the message call and the object property or method passed to the data-analysis parts container, receiving access to the resource defined in the data-analysis parts container associated with the object property or method passed to the data-analysis parts container.

17. The computer-readable medium of claim 16, wherein the data-analysis parts container is a component of a data-analysis template comprising a word processor document.

18. The computer-readable medium of claim 17, wherein the word processor document is generated using Word developed by Microsoft Corporation.

19. A computer-readable medium comprising a data-analysis template for use in data analysis in a word processor application, the data-analysis template comprising:
a serialized word processor document, wherein presentation content and data content may be separated;
at least one serialized data-analysis parts container; and
at least one program module for communicating at least one data-analysis part between the word processor document and the data-analysis parts container.

20. The computer-readable medium of claim 19, wherein the word processor document is generated using Word developed by Microsoft Corporation.

21. The computer-readable medium of claim 19, wherein the serialized data-analysis parts container is selected from a group of file types comprising:
an extensible markup language file;
a binary file; and
a text file.

22. The computer-readable medium of claim 19, wherein the serialized data-analysis parts container is embedded in the data content of the word processor document.

23. The computer-readable medium of claim 19, wherein the serialized data-analysis parts container is embedded in a bookmark in the word processor document.

24. The computer-readable medium of claim 19, wherein the serialized data-analysis parts container is embedded in a field in the word processor document.

25. The computer-readable medium of claim 19, wherein the program modules are generated using smart document technology.

26. The computer-readable medium of claim 25, wherein smart document technology is implemented using Visual Studio Tools for Office developed by Microsoft Corporation.
